(19) United States
(12) Patent Application Publication
(10) Pub. No.: US 2008/0284207 A1
(43) Pub. Date: Nov. 20, 2008

(54) Frame Structure for Receiving a Pivotally Mounted Truck Driver's Cab

(75) Inventors: Walter Bollinger, Winnenden (DE); Alexander Hummel, Stuttgart (DE); Gerd Martin, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/912,054

(22) PCT Filed: Apr. 12, 2006
(86) PCT No.: PCT/EP2006/003351

§ 371 Date: Jun. 4, 2008

(30) Foreign Application Priority Data
Apr. 22, 2005 (DE) 10 2005 018 830.3

(51) Int. Cl. B60R 27/00

(52) U.S. Cl. 296/190.05

(57) ABSTRACT

A front frame structure for receiving a pivotally mounted truck driver's cab is provided. The structure includes a mounting bracket for the connection of the pivotable driver's cab, which mounting bracket is fastened to the frame structure at connecting points, and with at least two longitudinal frame members which extend essentially along the longitudinal axis of the truck in the upper region of the frame structure. The longitudinal frame members themselves are designed with at least one deformation region for absorbing frontal collision energy, and the mounting bracket is arranged and designed to pass on collision energy from the driver's cab to the level of the longitudinal frame members.

### CROSS REFERENCE TO RELATED APPLICATIONS

This application is a continuation of PCT International Application No. PCT/EP2006/003351, filed Apr. 12, 2006, which claims priority under 35 U.S.C. § 119 to German Patent Application No. 10 2005 018 830.3 filed Apr. 22, 2005, the entire disclosures of which are herein expressly incorporated by reference.

### BACKGROUND AND SUMMARY OF THE INVENTION

The invention relates to a front frame structure for receiving a pivotally mounted truck driver's cab.

Front frame structures of this type, which are also referred to as a front module, conventionally comprise lateral longitudinal frame members and crossmembers on which the mounting of the pivotable driver's cab and spring mounting systems are fitted. The invention relates in particular to a frame structure of this type which is optimized with respect to the collision behavior for a frontal impact of the truck. The driver's cab, which is articulated above the frame structure, is particularly susceptible to severe damage in the event of an impact with the trailers of trucks traveling in front. This is because, in the event of a collision with a platform of another truck, most of the collision energy is introduced above the front frame structure of the vehicle body which leads to deformations in the region of the driver's cab.

Various means have been proposed to reduce the effects of such platform collisions with other trucks.

For example, the elements of the mounting of driver's cabs of this type have been configured as “crash elements” in order to absorb impact energy in the event of a frontal impact of the truck. An example of this type is disclosed in German patent application DE 198 31 329 A1. The bearing brackets of the mounting of a tiltable driver's cab are designed in a specifically deformable manner as crash elements. A drawback of this technique is that the mounting of the driver's cab has to be equipped with special deformable components or regions. Another solution with regard to the problem of a frontal impact in the upper region of the driver's cab of trucks consists in providing special, separate catch devices between the driver's cab and the front module of the frame structure. In German patent application DE 102 21 346 C1, a catch element is provided between a front-side frame of the frame structure and the bearing unit of the driver's cab, and therefore, in the event of an impact, collision energy can be absorbed by deformation of the catch element. A solution of this type likewise requires a special design and installation of extra crash elements to be provided between the bottom-side frame structure and the driver's cab. In addition, the effectiveness of the energy absorption is limited in this case, since the catch element has to be fitted as a separate component on the stiff parts of the frame structure by means of bolts or the like in order to prevent the driver's cab becoming detached from the frame structure. In addition, the relatively small size of such a deformable catch element is limited, and therefore effective absorption of collision energy can take place only in the event of relatively weak collisions.

German patent application DE 101 37 380 C1 discloses a suspension arrangement for a truck with at least one spring element and/or damper element which is supported at one end on a vehicle frame and at the other end on a driver's cab frame, the vehicle frame having two longitudinal members running parallel to each other in the longitudinal direction of the vehicle. In order to integrate the suspension arrangement into the vehicle frame in as space-saving a manner as possible, each longitudinal member is assembled from an upper cord, a lower cord and a plurality of vertical webs, the webs connecting the upper cord and lower cord to each other. In addition, a bracket is formed on the driver's cab frame for the spring element and/or damper element, said bracket engaging around the upper cord with vertical play, and the associated spring element and/or damper element being supported at one end on the lower cord and at the other end on the bracket between upper cord and lower cord. The respective upper cord of the longitudinal frame members and the bracket are designed in such a manner that they are deformed in the event of a collision.

By contrast, the invention provides a front frame structure of a pivotally mounted truck driver's cab, which has a further improvement in the collision behavior with respect to a frontal platform impact and can be realized at low costs and low outlay on installation.

This is achieved by the frame structure according to the invention with front frame structure (10) for receiving a pivotally mounted truck driver's cab, with a mounting bracket (1) for the connection of the pivotable driver's cab, which mounting bracket (1) is fastened to the frame structure at connecting points (2, 3), and with at least two longitudinal frame members (4) which extend essentially along the longitudinal axis of the truck in the upper region of the frame structure (10), characterized in that the longitudinal frame members (4) themselves are designed with at least one deformation region (5) for absorbing frontal collision energy, and in that the mounting bracket (1) is arranged and designed for passing on collision energy from the driver's cab to the level of the longitudinal frame members (4). Advantageous refinements and developments are also disclosed herein.

The front frame structure according to the invention of a pivotally mounted truck driver's cab has a mounting bracket for the connection of the pivotable driver's cab, which mounting bracket is fastened to the frame structure at connecting points, and at least two longitudinal frame members which extend essentially along the longitudinal axis of the truck in the upper region of the front frame structure. In the frame structure the longitudinal frame members themselves are designed with at least one deformation region for absorbing frontal collision energy, and the mounting bracket is arranged and designed for passing on frontal collision energy on the part of the driver's cab to the level of the longitudinal frame members. In the event of an impact that is level with the driver's cab, the collision energy introduced there is conducted downward, via the connection of the mounting bracket to the driver's cab, to the level of the longitudinal frame members and into the latter. The absorption of collision energy then takes place by deformation of the deformation regions of the longitudinal frame members, which deformation regions are directly coupled for this purpose to the mounting bracket. This simultaneously prevents the driver's cab from becoming detached from the frame structure, and the impact energy is conducted away to the frame structure located below said driver's cab. The frame structure itself, namely the longitudinal frame members thereof, are specifically designed with deformation regions in order to absorb the collision energy. This means that no additional crash elements are required in the region of the mounting of the driver's cab. In addition, no additional components have to be fitted during the production of the frame structure. Not least, the structure according to the invention with deformation regions integrated in the longitudinal frame members is marked by a lightweight construction. The longitudinal frame members, which are in any case of very stable design in the longitudinal direction of the vehicle, permit, together with the integrated deformation regions (or crash regions), a high absorption of energy in comparison to attached, separate deformation elements. In addition, the frame structure according to the invention can be used equally for different types of mounting and driver's cab connections without requiring changes in the structure.

According to one aspect of the invention, the bearing bracket has an upper connection to the longitudinal frame members and a lower connection to the frame construction below the longitudinal frame members. The upwardly projecting bearing bracket is therefore fastened to the bottom-side frame structure via two connecting points spaced apart vertically from each other, and therefore optimum introduction of collision energy level with the longitudinal frame members can take place. The lower connection forms a type of pivot point for the bearing bracket which therefore, in the event of collision energy impacting in the upper region, acts as a type of lever in order to pass on collision energy to the specific height of the longitudinal frame members.

According to a further aspect of the invention, the mounting bracket of the driver's cab has a connection to a driver's cab guide which is located level with an introduction of force in the case of a platform collision with a truck traveling in front, in particular is located in the central region of the height of the driver's cab. According to the invention, the passing on of collision energy on the part of the driver's cab via the mounting bracket is optimized when a collision with a truck traveling in front occurs (“platform collision”). Accordingly, all of the impact energy is passed on by the driver's cab level with and into the longitudinal members of the bottom-side frame structure in which said impact energy is at least partially dissipated by the deformation of the deformation regions. The mounting bracket according to the invention therefore has three connections, namely a connection on the driver's cab side, an upper connection level with the longitudinal frame members and a lower connection to a reinforcing component of the front, bottom-side frame structure. These three mounting bracket connections, which are spaced apart from one another in the vertical direction, conduct the impact energy in a specific manner to the level of the upper longitudinal frame members which are specifically configured to receive and absorb impact energy.

According to a further aspect of the invention, level with the longitudinal frame members, the mounting bracket is of a stiffened design in the longitudinal direction of the vehicle in relation to deformation. This can take place, for example, by a widened region in the longitudinal direction of the vehicle in this region. The mounting bracket can be designed with lateral stiffening ribs for stiffening it in relation to forces in the longitudinal direction of the vehicle.

According to a further aspect, the at least one deformation region of the longitudinal frame members is formed by a local variation of the profile shape of the longitudinal frame members. In this manner, the deformation region can be integrated at the same time as the profiles of the longitudinal frame members are produced, thus simplifying the production. The variation of the profile shape can be formed, for example, in the form of a change from a closed tubular profile to an open profile. As an alternative, or in addition, the deformation region can also be realized by a local tapering of the material, a local change of the material or by local material cutouts.

According to a further advantageous refinement of the invention, the deformation region of the longitudinal frame members is arranged directly behind the upper connection of the mounting bracket in the direction of travel. The deformation in the event of a frontal collision is located here directly below the driver's cab, and damage to rear components of the frame structure of the truck is prevented. The deformation region according to the invention is located at the same height as and directly as an extension of the longitudinal frame members, and therefore maximum energy absorption is achieved in the deformation region.

### BRIEF DESCRIPTION OF THE DRAWINGS

Further advantages and features of the invention can be gathered from the detailed description below in which the invention is described in more detail with regard to the exemplary embodiments illustrated in the attached drawings, in which:

FIG. 1 shows a schematic side view of an exemplary embodiment of the frame structure according to the invention to illustrate the principle of the invention; and

FIG. 2 shows a perspective detailed view of an exemplary embodiment of the longitudinal frame member according to the invention with the deformation region.

### DETAILED DESCRIPTION

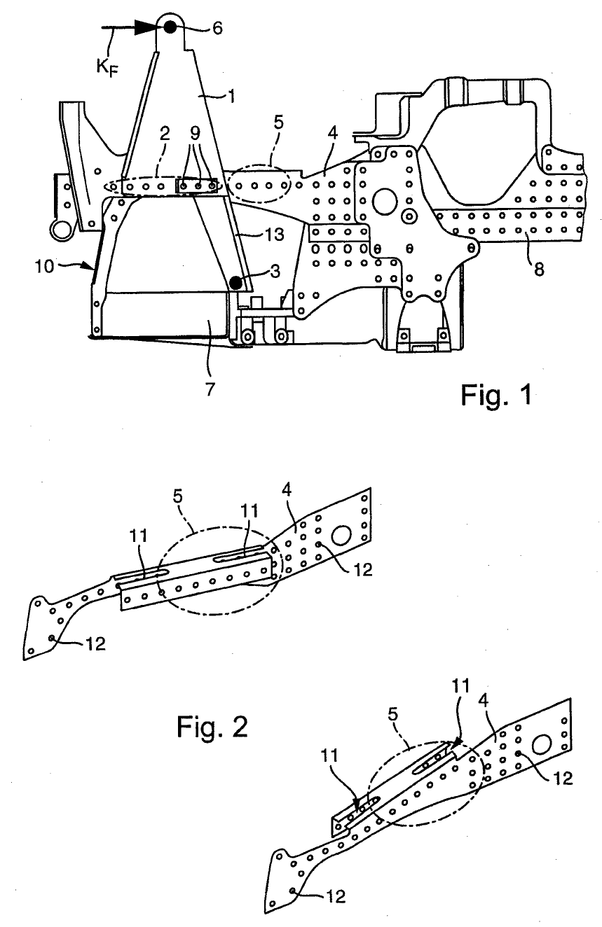

FIG. 1 schematically illustrates, in a side view, a front frame structure 10 or front module of a truck. The frame structure comprises at least two longitudinal frame members 4 which extend along a longitudinal axis of the truck in the upper region of the frame structure 10. Lower longitudinal members 7 are provided in the lower region of the front frame structure 10. A mounting bracket 1 is fastened to the frame structure 10 via connecting points 2, 3. The upper connection 2 of the mounting bracket 1 is located level with the longitudinal frame members 4 whereas the lower connection 3 is located level with the lower longitudinal members 7 on the lower side of the front frame structure 10. The mounting bracket 1 furthermore has a connection 6 which is on the driver's cab side and via which the mounting bracket 1 is coupled to a driver's cab guide (not illustrated). In the event of an impact with a platform of a truck traveling in front, a collision force K_{F} is introduced level with the driver's cab, which is indicated in FIG. 1 by the arrow.

According to the invention, the mounting bracket 1 is coupled via its connecting points 2, 3 to the front frame structure 10 in such a manner that the collision force K_{F} is passed on level with the longitudinal frame members 4. According to the invention, the longitudinal members 4 are each provided with a deformation region 5 which is designed to absorb and consume the collision energy. Specifically, a “crash region” is integrated directly into the longitudinal frame members 4 by means of the deformation regions 5. It is therefore not required to provide the mounting of the driver's cab itself with deformation elements or to provide separate deformation elements in addition to the conventional components of the frame structure 10. Absorption of the collision energy level with the lateral longitudinal frame members 4 in the deformation regions 5 effectively prevents rear components, such as the rear longitudinal members 8, being damaged. The longitudinal frame members 4 are fitted, for example, via bolted connections 9, and therefore a simple exchange after a collision can take place. By arranging and designing the mounting bracket 1 with a lower connection 3 and an upper connection 2, a specific conducting away of collision forces level with the longitudinal frame members 4 and the deformation regions 5 is realized by the mounting bracket 1 forming a type of lever with articulation on the lower connection 3. The mounting bracket 1 is designed with an expanded section in the region of the connection 2 to the longitudinal frame members 4, and therefore further passing on of force can take place here without deformation of the mounting bracket 1. In the exemplary embodiment shown, the mounting bracket 1 is formed, toward the lower connection 3, with a support section which extends obliquely to the rear counter to the direction of travel and is stiffened by an angled edge 13. With its widened central region and the obliquely arranged lower support section, the mounting bracket 1 forms a locally stiffened lever arm which is optimized in respect of conducting away force into the deformation body, is articulated on the lower connecting point 3 and passes on collision energy introduced level with the driver's cab connection 6 into the deformation regions 5 without being deformed itself. The rear deformation regions 5 can be realized by any means known to a person skilled in the art for this and can be formed, for example, by a variation of the profile shape, a local tapering of the material, a change of the material or by material cutouts.

FIG. 2 illustrates, in a perspective view, an exemplary embodiment of longitudinal frame members 4 for the right and left side, in which the deformation region 5 is formed by a downwardly open U profile. Slot-shaped recesses 11 which are open toward the ends of the U profile are formed on the upper side of the U profile and assist the longitudinal frame members being pushed together in the event of a crash. In addition, fastening holes 12 are provided on front and rear sections of the longitudinal frame members 4 which each project from the deformation region 5. Since the deformation region 5 is therefore integrated directly into the longitudinal frame member 4, separate crash elements or deformation bodies do not need to be attached in the structure.

All of the features and elements illustrated in the description, the claims below and the drawing may be essential to the invention both individually and in any desired combination with one another.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A front frame structure that receives a pivotally mounted truck driver's cab, comprising:
a mounting bracket that connects the pivotable driver's cab, the mounting bracket is fastened to the frame structure at connecting points; and
at least two longitudinal frame members which extend essentially along the longitudinal axis of the truck in an upper region of the frame structure,
wherein the longitudinal frame members include at least one deformation region that absorbs frontal collision energy, and the mounting bracket is arranged and designed to pass on collision energy from the driver's cab to a level of the longitudinal frame members.

11. The frame structure as claimed in claim 10, wherein the mounting bracket has an upper connection to the longitudinal frame members and a lower connection below the longitudinal frame members to the frame structure.

12. The frame structure as claimed in claim 10, wherein the mounting bracket has a connection to a driver's cab guide which is located in the central region of the height of the driver's cab.

13. The frame structure as claimed in claim 10, wherein level with the longitudinal frame members, the mounting bracket is stiffened in the longitudinal direction of the vehicle in relation to deformation.

14. The frame structure as claimed in claim 10, wherein the deformation region is formed by a local variation of the profile shape of the longitudinal frame members.

15. The frame structure as claimed in claim 10, wherein the deformation region is formed by a local tapering of a material of the longitudinal frame members.

16. The frame structure as claimed in claim 10, wherein the deformation region is formed by a local change of a material of the longitudinal frame members.

17. The frame structure as claimed in claim 10, wherein the deformation region is realized by local material cutouts.

18. The frame structure as claimed in claim 10, wherein the deformation region lies directly behind an upper connection of the mounting bracket in a direction of travel.
